(19) United States
(12) Patent Application Publication
(10) Pub. No.: US 2026/0112868 A1
(43) Pub. Date: Apr. 23, 2026

(54) HOT LINE CLAMP

(71) Applicant: INCESA INDÚSTRIA DE COMPONENTES ELÉTRICOS LTDA, Olímpia (BR)

(72) Inventor: Maurício BENATTI, Olímpia (BR)

(73) Assignee: INCESA INDÚSTRIA DE COMPONENTES ELÉTRICOS LTDA, Olímpia (BR)

(21) Appl. No.: 19/364,029

(22) Filed: Oct. 21, 2025

(30) Foreign Application Priority Data
Oct. 22, 2024 (BR) 1020240218949

(51) Int. Cl. H02G 1/02

(52) U.S. Cl. CPC H02G 1/02

(57) ABSTRACT

A hot line clamp for use in 15, 25 and 36 kV electrical power distribution networks is disclosed. The clamp includes an eyebolt receiver body configured to receive a cable or stirrup and a branch connection. In one embodiment, torque applied to a nut causes radial compression of a conductor against the body, distributing force uniformly. In another embodiment, torque applied to a screw produces axial compression, and the screw includes a fracture region that breaks at a predetermined torque threshold, indicating proper tightening and preventing over-torque. Both embodiments include a compression system that maintains electrical and mechanical integrity under thermal cycling.

### CROSS REFERENCE TO RELATED APPLICATIONS

The present application claims the benefit of and priority to Brazilian Patent Application No. BR 10 2024 021894 9, filed on Oct. 22, 2024, the entirety of which is hereby incorporated by reference in its entirety for any purpose whatsoever.

### FIELD OF DISCLOSURE

The present application refers to improvements in hot line clamps for 15, 25 and 36 kV electricity distribution networks. The disclosure generally relates to live-line clamps or hot line connectors configured for safe and reliable use in medium-voltage electrical power distribution networks. More specifically, the disclosure concerns a new clamp configuration that presents innovative technical characteristics in relation to the branch connection, wherein the conductor is no longer compressed axially by torque applied directly to a screw but is instead compressed radially by torque applied to a hexagonal nut. This structural and functional arrangement distributes the applied force more uniformly around the conductor, reducing strand damage and enhancing mechanical and electrical performance. Certain embodiments additionally provide a torque-limiting screw with a fracture region, ensuring correct torque application and preventing conductor breakage.

### BACKGROUND

It is known that a hot line clamp (GLV type) comprises a means of connection used in overhead power distribution networks to interrupt a certain section of the line in copper, aluminum AC, or CAA cables and to form connections between the main network and the branches or between the main network and equipment without the need to handle or disconnect other equipment such as fuse switches. Such clamps can be operated while the line remains energized, provided that appropriate tools and personal protective equipment (PPE) are used, particularly during live maintenance operations.

In general, conventional hot line clamps are formed by a vise-type connector to accommodate the main cable and a pressure-type connector to accommodate the branch cable. The portion for accommodating the main cable provides a base with a threaded hole for orthogonal assembly of a drive screw, the drive screw having a receiving eyelet configured to receive an insulated maneuvering stick.

A series of configurations are known in the state of the art, in which, for example, document BR 102021014564, owned by the current applicant, reveals a hot line clamp of the type for the electricity distribution network that integrates, in the receiving body, the compression system by a set of springs and actuation of the eyebolt by mechanical cam for axial movement through tightening with the aid of the maneuvering rod associated with the predictability of a tilting member installed on a spring-loaded shaft.

Document CN115347498, in turn, discloses a bypass cable support rod comprising a first fixing end, a first connecting rod, a second fixing end, a second connecting rod and an adjusting sleeve. The first fixing end is connected to one end of a first connecting rod, the other end of the first connecting rod is connected to one end of a second connecting rod via an adjusting sleeve, and the other end of the second connecting rod is connected to the second fixing end.

Document KR101946206, in another strategy, discloses a lifting arm, and more specifically, a lifting arm for an indirect live wire work installed on an electric pole, and an indirect hot line safety separation method using the same, which can use a separate auxiliary crossbar clamping device to conveniently perform wiring operations such as installing separation on a lower part of a crossbar, holding a wire and freely adjusting the wire in all directions for an indirect live wire work, adjusting the distance of a wire, and the like, and can perform wiring operations while a wire is safely locked and accommodated on an opening/closing roller, thereby preventing an accident due to a direct live wire work in advance, ensuring a sufficient safety operation space for a crossbar and electric pole replacement process.

However, none of the prior art documents provide for a hot line clamp that compresses the conductor radially, a factor that distributes the force applied to the conductor. Accordingly, there exists a need for a hot line clamp that can apply uniform compression forces while also providing safety, reliability, and torque control suitable for energized network applications.

### SUMMARY

The present application relates to a hot line clamp of the type for 15, 25 and 36 Kv electrical power distribution network with innovative elements in the branch connection. The closest prior art, BR102021014564, requires a hexagonal screw, which when subjected to torque compresses the conductor, the torque being applied directly to the screw, which compresses the conductor axially against the body to thus perform the application, while in the hot line clamp according to the present application, both the main connection and the branch connection are adjusted. In contrast, the present disclosure provides a configuration in which torque is applied to a hexagonal nut, causing radial compression of the conductor against the body instead of axial compression, thereby redistributing force around the conductor and enhancing the electrical contact interface. In other embodiments, a torque-limiting screw with a defined fracture region provides controlled axial compression. Both configurations may include spring-biased elements to maintain pressure under varying thermal and mechanical conditions

### BRIEF DESCRIPTION OF THE DRAWINGS

Various aspects of the present disclosure are discussed herein with reference to the accompanying Figures. It will be appreciated that for simplicity and clarity of illustration, elements shown in the drawings have not necessarily been drawn accurately or to scale. For example, the dimensions of some of the elements can be exaggerated relative to other elements for clarity or several physical components can be included in one functional block or element. Further, where considered appropriate, reference numerals can be repeated among the drawings to indicate corresponding or analogous elements. For purposes of clarity, however, not every component can be labeled in every drawing. The Figures are provided for the purposes of illustration and explanation and are not intended as a definition of the limits of the disclosure.

FIG. 1 illustrates a prior art hot line clamp.

FIG. 2 illustrates a first embodiment of the hot line clamp according to the present application.

FIG. 3 illustrates a second embodiment of the hot line clamp according to the present application.

FIG. 4 illustrates a detailed application of the derivation of a prior art model for hot line clamp.

FIG. 5 illustrates a detailed view of the application of the derivation of a first embodiment of the hot line clamp according to the present application.

FIG. 6 illustrates a detailed view of the application of the derivation of a second embodiment of the hot line clamp according to the present application.

### DETAILED DESCRIPTION

The following detailed description refers to exemplary embodiments of the invention. It should be understood that the embodiments are described for purposes of illustration and are not intended to limit the scope as defined by the appended claims. The subject technology overcomes many of the prior art problems associated with hot line clamps. The advantages, and other features of the technology disclosed herein, will become more readily apparent to those having ordinary skill in the art from the following detailed description of certain exemplary embodiments taken in combination with the drawings and wherein like reference numerals identify similar structural elements. It should be noted that directional indications such as vertical, horizontal, upward, downward, right, left and the like, are used with respect to the figures and not meant in a limiting manner.

The present application relates to a hot line clamp of the type for 15, 25 and 36 Kv electrical power distribution network with innovative elements in the branch connection 1. The clamp is particularly suited for field use under live-line conditions and can be operated using an insulated maneuvering rod.

With reference to the drawings accompanying this application, the hot line clamp of the type for 15, 25 and 36 kV electrical power distribution network according to this application is comprised of an eyebolt receiver body 3 that also receives a cable or stirrup 11, as well as a connection 1 of the branch cable 12. The body 3 may be made of a conductive aluminum alloy or other corrosion-resistant conductive material suitable for electrical applications.

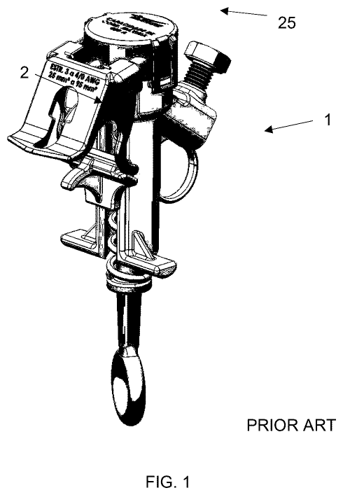

As illustrated in FIG. 1, the clamp structure 13 includes, in the receiving body 1, a set of springs 14 that configure the compression system 7 by actuating the eyebolt 15, which, by means of a transverse pin 16, develops axial movement in rotation and vertical displacement based on a mechanical cam 17 provided inside the enlarged head 18 of the receiving body 3, through a ¼ turn rotation of the eyebolt 15 with the aid of the maneuvering rod 19, associated with the pendulum movement of a tilting member 20, in turn mounted on an axle 21 with a spring 22 in an appendix hole 23 that develops orthogonally in relation to the external surface 24 of the enlarged head 18, also comprising two ramps 25 that operate together with a mobile saddle 26 moved by the ascension and axial movement of the same eyebolt 15 for engaging the stirrup/cable 11 when installing the clamp 13 in the electricity distribution network 27. The receiver body houses a compression system 7 configured to generate axial or radial forces depending on the embodiment. The system may include one or more mechanical cams, springs, or pins as described below.

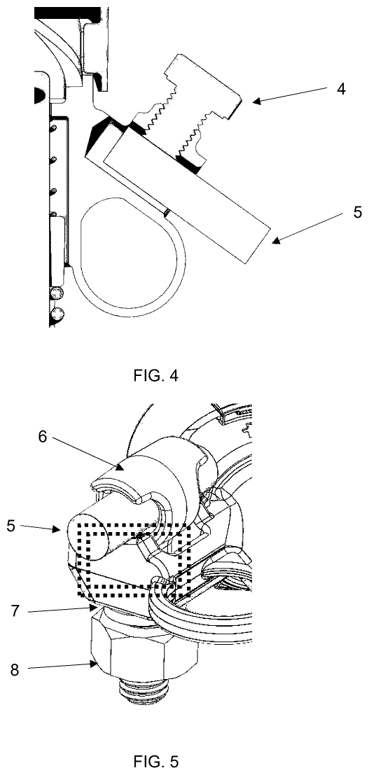

In other words, and as shown in FIG. 3, the branch connection 28 in the closest state-of-the-art hot line clamp model 29 consists of a hexagonal screw 4, which compresses the conductor 5 when subjected to torque. Thus, the torque is applied directly to the screw 4, which compresses the conductor 5 axially against the body 3 region marked in FIG. 4 to thus perform the application.

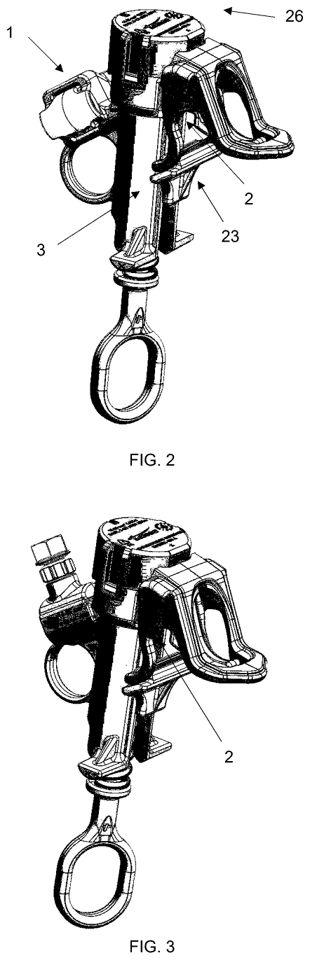

As shown in FIG. 2 to FIG. 5, in a first embodiment, the present application discloses a hot line clamp 30 comprising significant differences in the configuration of the diverter eyelet 6 in relation to the conductor 5. Here, the torque is applied directly to the nut 8. The diverter eyelet 6 compresses the conductor 5 radially against the body 3 region marked in FIG. 5 to thus perform the application. This configuration also comprises a compression system 7 in order to avoid relaxation due to thermal effect and a hexagonal nut 8 or self-locking nut. This embodiment distributes compressive force around the circumference of the conductor and minimizes strand deformation. The nut 8 may be a standard hexagonal nut or a self-locking nut to resist loosening under vibration. The compression system 7 includes a spring assembly or equivalent resilient mechanism to maintain stable pressure and prevent relaxation due to thermal effects.

In summary, the branch connection 1 of the closest prior art compresses the conductor 5 axially torque applied to the screw itself, while the connection 1 of this first modality compresses the conductor 5 radially torque applied to the hexagonal nut 8, a factor that distributes the force applied to the conductor 5. The radial compression arrangement also enables easier installation torque control and improved corrosion resistance at the conductor interface.

As shown in FIG. 3, in a second embodiment, the present application discloses a hot line clamp 30 comprising further significant differences in the shunt eyelet 6 configuration relative to the conductor 5.

FIG. 4 illustrates, in greater detail, the use of a hexagonal screw 4 in the connection with a conductor 5. In terms of the branch connection 1, in this clamp the torque is applied directly to the screw 9, which compresses the conductor 5 axially against the body 3 region marked in FIG. 4 to thus perform the application.

The second embodiment according to the present application, as illustrated in FIG. 5, comprises a fracture region 10 of the screw, in which a torque limiting screw 9 acts with respect to the connection with the conductor 5. Here, in terms of the branch connection 1, the torque is applied directly to the screw 9, which compresses the conductor 5 axially against the body 3 to perform the application. However, the screw 9 fractures in a specific torque range, which prevents excessive torque from being applied, which in turn prevents the wires of the conductor 5 from breaking.

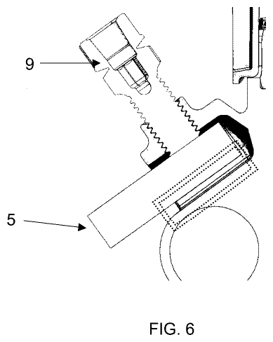

In other words, as illustrated in FIG. 6, the branch connection 1 of this second modality compresses the conductor 5 axially torque applied to the screw itself, but the screw 9 fractures in a specific torque range, indicating that the branch connection 1 has been completed, a factor that prevents excessive or insufficient tightening of the connection.

It is acknowledged that when this application is put into practice, modifications may be introduced with regard to certain details of construction and shape, without this implying a departure from the fundamental principles that are clearly substantiated in the framework of the claims, thus understanding that the terminology used was not intended to be limiting. Such modifications may include alternate materials, geometries, or assembly sequences while preserving the disclosed compression and torque-limiting functionality.

It will be appreciated by those of ordinary skill in the pertinent art that the functions of several elements can, in alternative embodiments, be carried out by fewer elements, or a single element. Similarly, in some embodiments, any functional element can perform fewer, or different, operations than those described with respect to the illustrated embodiment. Also, functional elements shown as distinct for purposes of illustration can be incorporated within other functional elements in a particular embodiment. For example, the compression system may be implemented by a single integrated subassembly combining the spring set and cam mechanism.

While the subject technology has been described with respect to various embodiments, those skilled in the art will readily appreciate that various changes and/or modifications can be made to the subject technology without departing from the scope of the present disclosure. The described components may be manufactured using standard metal forming, forging, or casting processes, and assembled with conventional tools. Equivalent variants that perform substantially the same function in substantially the same way to achieve substantially the same result fall within the intended scope of the claims.

### LIST OF REFERENCE NUMERALS

1 branch connection
2 main connection
3 body
4 hexagonal screw
5 conductor
6 drift eyelet
7 compression system
8 hex nut
9 limiting screw
10 screw fracture region
11 cable or stirrup
12 branch cable
13 clamp structure
14 set of springs
15 eyebolt
16 transverse pin
17 mechanical cam
18 enlarged head
19 maneuvering rod
20 tilting member
21 axle
22 spring
23 appendix hole
24 external surface
25 two ramps
26 mobile saddle
27 electricity distribution network
28 branch connection
29 prior art clamp model
30 hot line clamp

What is claimed is:

1. A hot line clamp for use in an electrical power distribution network rated for 15, 25, or 36 kilovolts, comprising:
an eyebolt receiver body configured to receive a cable or stirrup and a branch connection;
a branch eyelet configured to receive a conductor;
a nut coupled to the branch eyelet and configured such that torque applied to the nut causes the branch eyelet to compress the conductor radially against the body; and
a compression system configured to prevent relaxation of the connection due to thermal effects,
wherein the nut comprises a hexagonal nut or a self-locking nut.

2. The hot line clamp of claim 1, further comprising a torque-limiting screw having a fracture region, the screw being configured to apply an axial compression force to a conductor against the body, wherein the screw fractures at a predetermined torque range to indicate completion of the branch connection and to prevent excessive torque that could damage the conductor strands.

3. A hot line clamp for a power distribution network comprising:
a receiver body having a cavity for receiving a main cable or stirrup and a branch conductor;
a branch eyelet positioned to compress the branch conductor radially relative to the receiver body;
a nut threadably engaged with the eyelet and configured such that torque applied to the nut produces a radial compression of the conductor against the receiver body; and
a resilient compression assembly disposed between the nut and the receiver body to maintain clamping force during thermal cycling.

4. The hot line clamp of claim 3, wherein the resilient compression assembly comprises a plurality of springs arranged to compensate for thermal expansion and contraction of the conductor.

5. The hot line clamp of claim 3, wherein the nut is a self-locking hexagonal nut configured to maintain torque under vibration.

6. The hot line clamp of claim 3, wherein the branch eyelet includes a concave surface configured to distribute contact pressure substantially uniformly around the conductor circumference.

7. The hot line clamp of claim 3, wherein the receiver body includes an enlarged head portion defining a transverse pin coupled to an eyebolt that is rotatable by an insulated operating rod.

8. The hot line clamp of claim 3, wherein the clamp further comprises a mechanical cam configured to actuate a movable saddle that engages a cable or stirrup in the main connection.

9. The hot line clamp of claim 3, wherein the receiver body and the branch eyelet are composed of a corrosion-resistant conductive alloy.

10. The hot line clamp of claim 3, wherein the clamp is configured for installation on an energized line using a hot-stick maneuvering tool.

11. The hot line clamp of claim 3, wherein the compression assembly maintains electrical continuity and mechanical retention under thermal and mechanical vibration conditions.

12. A hot line clamp for a power distribution network comprising:
a receiver body configured to receive a conductor;
a torque-limiting screw threadably engaged with the receiver body and configured to apply an axial compression force pressing the conductor against the receiver body; and
a fracture region formed along the screw, the fracture region being configured to break at a predetermined torque threshold to indicate proper installation and to prevent over-tightening of the conductor.

13. The hot line clamp of claim 12, wherein the fracture region comprises a necked section of reduced cross-section between a head portion and a threaded portion of the screw.

14. The hot line clamp of claim 12, wherein the screw is formed of a conductive metal having a yield strength corresponding to the desired torque limit.

15. The hot line clamp of claim 12, wherein the predetermined torque threshold is selected to avoid strand breakage in the conductor.

16. The hot line clamp of claim 12, further comprising a visual or tactile indicator configured to signal fracture completion of the screw.

17. The hot line clamp of claim 12, wherein the receiver body includes a spring-biased compression system configured to maintain electrical contact after the screw fractures.

18. The hot line clamp of claim 12, wherein the receiver body includes a maneuvering eyelet adapted for engagement by an insulated operating rod.

19. The hot line clamp of claim 12, wherein the clamp further includes an enlarged head defining an internal cavity housing a cam mechanism for controlling clamp actuation.

20. The hot line clamp of claim 12, wherein the clamp is configured for both main line and branch line connections in energized electrical distribution networks.
